(19) United States
(12) Patent Application Publication
(10) Pub. No.: US 2021/0362516 A1
(43) Pub. Date: Nov. 25, 2021

(54) HEATING DEVICE

(71) Applicant: SEIKO EPSON CORPORATION, Tokyo (JP)

(72) Inventors: Tomohiro YODA, MATSUMOTO-SHI (JP); Yasuo NARAMATSU, MATSUMOTO-SHI (JP)

(21) Appl. No.: 17/321,743

(22) Filed: May 17, 2021

(30) Foreign Application Priority Data
May 20, 2020 (JP) 2020-087939

(51) Int. Cl. B41J 11/00

(52) U.S. Cl. CPC B41J 11/0022

(57) ABSTRACT

A heating device includes a heating unit configured to heat a medium in a non-contact manner, a reflector configured to reflect heat rays of the heating unit toward the medium, a flow path member including a gas flow path disposed between a suction port and an outlet, an air blowing unit configured to generate an air flow so that gas is sucked from the suction port and is blown out from the outlet, a first cutting unit configured to stop a current to the heating unit when a temperature reaches a predetermined temperature, and a second cutting unit configured to stop the current to the heating unit when a temperature reaches a predetermined temperature. The first cutting unit is disposed in the gas flow path, located in the vertically upward direction with respect to the heating unit. The second cutting unit is in contact with the reflector.

The present application is based on, and claims priority from JP Application Serial Number 2020-087939, filed May 20, 2020, the disclosure of which is hereby incorporated by reference herein in its entirety.

### BACKGROUND

### 1. Technical Field

The present disclosure relates to a heating device suitable for drying a medium on which an image is formed by ejecting ink.

### 2. Related Art

Conventionally, a printing apparatus having a drying device (heating device) for drying a liquid (ink) applied to a continuous paper (medium) has been proposed (for example, JP-A-2018-12323).

The drying device disclosed in JP-A-2018-12323 includes an infrared heater to heat a medium, an idler roller to support the medium, and a temperature detector to detect a temperature of the idler roller, the infrared heater is turned on while the medium is conveyed and is turned off when the medium is stopped, and further the infrared heater is turned off when the temperature detected with the temperature detector is a predetermined temperature or higher.

The temperature detector is disposed opposite the infrared heater via the idler roller. The temperature detector indirectly detects the temperature of the idler roller that receives the same heat energy as the medium, thus an abnormal temperature is detected.

However, in the drying apparatus disclosed in JP-A-2018-12323, there is a problem in that when drying is performed by blowing in addition to drying by the heat energy of an infrared heater, it is difficult to correctly detect the abnormal temperature.

### SUMMARY

A heating device according to the present disclosure is a heating device configured to heat a medium supported by a support surface inclined in a vertically downward direction toward downstream in a transport direction and transported in the transport direction, and includes a heating unit disposed facing the support surface and configured to heat the medium in a non-contact manner, a reflector configured to reflect heat rays of the heating unit toward the medium, a flow path member disposed at an opposite side to the support surface with respect to the heating unit and is inclined in a vertically upward direction toward upstream in the transport direction, the flow path member including a suction port disposed in the vertically downward direction, an outlet disposed in the vertically upward direction, and a gas flow path disposed between the suction port and the outlet, an air blowing unit configured to generate an air flow in the gas flow path so that gas is sucked from the suction port and is blown out between the support surface and the heating unit from the outlet, a first cutting unit disposed in the gas flow path and located in the vertically upward direction with respect to the heating unit, the first cutting unit being configured to stop supplying current to the heating unit when a predetermined temperature is reached, and a second cutting unit in contact with the reflector, the second cutting unit being configured to stop the current to the heating unit when a predetermined temperature is reached.

### BRIEF DESCRIPTION OF THE DRAWINGS

FIG. 1 is a schematic cross-sectional view illustrating an overview of a recording apparatus.

FIG. 2 is a plan view of a heating device viewed in a direction from a second member toward a second support surface.

FIG. 3 is a schematic cross-sectional view illustrating a state of the recording apparatus when an air blowing fan is stopped.

FIG. 4 is a schematic cross-sectional view illustrating a state of the recording apparatus when jam of a medium occurs.

### DESCRIPTION OF EXEMPLARY EMBODIMENTS

### 1. Embodiment

1.1 Overview of Recording Apparatus

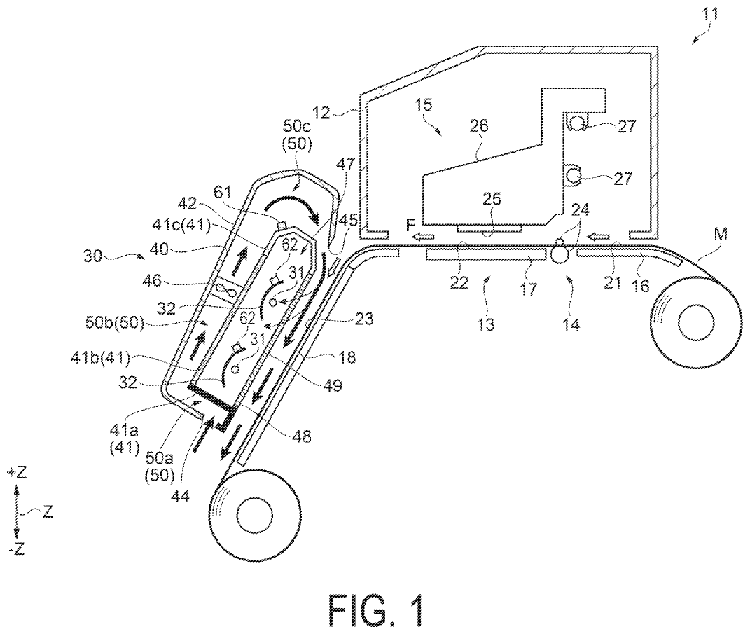

FIG. 1 is a schematic cross-sectional view illustrating an overview of a recording apparatus 11.

In FIG. 1, a direction in which a medium M is transported is illustrated by a white arrow, and hereinafter, the direction in which the medium M is transported is referred to as a transport direction F. Further, a direction in which gas flows in a heating device 30 is illustrated by a thick solid arrow.

Further, in the following description, a height direction of the recording apparatus 11, that is, a vertical direction is denoted as a Z-axis direction. In the Z-axis direction, a direction opposite to a gravity direction is a +Z direction, which is an example of a vertically upward direction in the present application. In the Z-axis direction, a direction toward the gravity direction is a −Z direction, which is an example of a vertically downward direction in the present application.

First, an outline of the recording apparatus 11 will be described with reference to FIG. 1.

As illustrated in FIG. 1, the recording apparatus 11 is an ink jet-type printer having the heating device 30 according to the present embodiment, and the recording apparatus 11 can record (print) an image such as a letter, a photograph, or the like on the medium M by ejecting ink.

The recording apparatus 11 includes a container 12, a support unit 13 capable of supporting the medium M, and a transport unit 14 that transports the medium M along the support unit 13. Further, the recording apparatus 11 includes a recording unit 15 disposed in the container 12, and a heating device 30 disposed outside the container 12. The heating device 30 heats the medium M on which the image is formed by ejecting the ink. The medium M is, for example, a roll paper wound in a cylindrical shape.

The support unit 13 includes a first support plate 16, a second support plate 17, and a third support plate 18. The first support plate 16, the second support plate 17, and the third support plate 18 are arranged in this order in the transport direction F from upstream thereof in which the medium M is transported by the transport unit 14.

The first support plate 16 and the second support plate 17 are disposed facing the container 12. A surface of the first support plate 16 facing the container 12 is a first support surface 21 configured to support the medium M. A surface of the second support plate 17 facing the container 12 is a second support surface 22 configured to support the medium M. In the support plates 16 and 17, the surfaces facing upward in the vertical direction are the support surfaces 21 and 22.

The third support plate 18 is disposed facing the heating device 30. A surface of the third support plate 18 facing the heating device 30 is a third support surface 23 configured to support the medium M. In the third support plate 18, the surface facing upward in the vertical direction is the third support surface 23.

The third support surface 23 is an example of the support surface in the present application.

The transport unit 14 includes, for example, a transport roller 24 that transports the medium M by rotating in contact with the medium M. The transport roller 24 is disposed between the first support plate 16 and the second support plate 17 in the transport direction F. The medium M is transported by the transport unit 14 in a direction from the first support surface 21 to the third support surface 23 while being supported by the first support surface 21, the second support surface 22, and the third support surface 23.

The transport direction F of the medium M transported by the transport unit 14 is a direction along the first, second, and third support surfaces 21, 22, and 23.

The recording unit 15 includes a head 25 that ejects ink. The head 25 is disposed facing the second support plate 17, and is capable of ejecting the ink onto the medium M supported by the second support plate 17. The recording unit 15 is configured to record an image on the medium M by ejecting the ink onto the medium M. The ink contains a color material, a solvent that disperses (or dissolves) the color material, and the like. In the present embodiment, water is used as the solvent.

Specifically, the recording unit 15 includes a carriage 26 that holds the head 25, and a guide shaft 27 that guides a movement of the carriage 26. The head 25 ejects ink while reciprocating with the carriage 26 along the guide shaft 27 extending in a width direction of the medium M and forms an image on the medium M. Further, the width direction of the medium M is a direction that intersects with the transport direction F, and is hereinafter simply referred to as a width direction.

1.2 Overview of Heating Device

Next, an overview of the heating device 30 included in the recording apparatus 11 will be described.

The third support plate 18 supports the medium M downstream of the recording unit 15 in the transport direction F. The third support surface 23 of the third support plate 18 is a surface configured to support the medium M to which the ink is attached by the recording unit 15, and is inclined in the −Z direction (vertically downward direction) toward the downstream of the transport direction F.

The heating device 30 is disposed facing the third support surface 23 of the third support plate 18, and is disposed at a slight interval from the third support surface 23. The heating device 30 heats the medium M while blowing gas onto the medium M supported by the third support surface 23 and transported in the transport direction F, and evaporates water of the ink attached to the medium M.

That is, the heating device 30 simultaneously performs drying by heating and drying by blowing air to the medium M transported in the transport direction F.

The heating device 30 includes a heating unit 31 that is disposed facing the third support surface 23 and heats the medium M in a non-contact manner, a reflector 32 that reflects heat rays (infrared rays) of the heating unit 31 toward the medium M, and a flow path member 40 that is disposed at an opposite side to the third support surface 23 with respect to the heating unit 31 and is inclined in the +Z direction (vertically upward direction) toward upstream in the transport direction F.

The heating unit 31 may be a heater capable of heating the medium M in a non-contact manner, and a sheathed heater, a halogen heater, or the like can be used. The heating unit 31 has a cylindrical shape that is long in the width direction. A dimension in the width direction of the heating unit 31 is longer than a dimension in the width direction of the medium M. A plurality of the heating unit 31 (two in the present embodiment) are disposed at positions that face the third support surface 23 at intervals in the transport direction F.

The reflector 32 is disposed at a position opposite to the third support surface 23 with respect to the heating unit 31 and has a concave curved reflecting surface. A dimension in the width direction of the reflector 32 is longer than a dimension in the width direction of the heating unit 31. The reflector 32 is provided at each of the heating units 31 disposed at intervals in the transport direction F. The reflector 32 reflects heat rays (infrared rays) of the heating unit 31 toward the third support surface 23 (medium M).

As a result, most of radiation from the heating unit 31 is directed toward the third support surface 23, and the medium M supported by the third support surface 23 is heated by the radiation.

The flow path member 40 includes a first member 41 disposed at the heating unit 31 side and a second member 42 disposed at the opposite side to the heating unit 31 with respect to the first member 41. The first member 41 and the second member 42 incline in the +Z direction (vertically upward direction) toward the upstream of the transport direction F.

By joining the first member 41 and the second member 42, the flow path member 40 that is disposed at the opposite side to the third support surface 23 with respect to the heating unit 31, and is inclined in the +Z direction (vertically upward direction) toward the upstream of the transport direction F is formed.

A cavity 50 is formed inside the flow path member 40. The cavity 50 formed inside the flow path member 40 is a flow path of gas, and will be hereinafter referred to as a gas flow path 50. Further, a suction port 44 through which the gas is sucked is disposed downstream of the gas flow path 50 in the transport direction F. An outlet 45 from which the gas is blown out is disposed at upstream of the gas flow path 50 in the transport direction F. The suction port 44 is disposed vertically downward (in the −Z direction), and the outlet 45 is disposed vertically upward (in the +Z direction).

As described above, the flow path member 40 includes the suction port 44 disposed in the vertically downward direction (−Z direction), the outlet 45 disposed in the vertically upward direction (+Z direction), and the gas flow path 50 disposed between the suction port 44 and the outlet 45.

The gas flow path 50 includes a first portion 50a that starts from the suction port 44 and extends away from the third support surface 23, a second portion 50b that inclines in the +Z direction (vertically upward direction) toward the upstream of the transport direction F, and a third portion 50c that inverts a flow direction of the gas. Further, the outlet 45 is disposed at an end of the third portion 50c that inverts the flow direction of the gas. In a cross-sectional view of the gas flow path 50, the first portion 50a and the second portion 50b have a linear shape extending in one direction, and the third portion 50c has a curved shape curves into a U-shape.

The first member 41 includes a first portion 41a that starts from the suction port 44 and extends away from the third support surface 23, a second portion 41b that inclines in the +Z direction (vertically upward) toward the upstream of the transport direction F, and a third portion 41c that inverts the flow direction of the gas. In a cross-sectional view of the first member 41, the first portion 41a and the second portion 41b have a linear shape extending in one direction, and the third portion 41c has a curved shape curves into a U-shape. A portion of the first member 41 in the +Z direction (vertically upward direction) is the third portion 41c.

In FIG. 1, the first portion 41a located vertically downward is illustrated in solid black, the third portion 41c located vertically upward is illustrated in solid white, and the second portion 41b located between the first portion 41a and the third portion 41c is shaded.

Further, in the first member 41, the first portion 41a, the second portion 41b, and the third portion 41c form a recess 47 recessed in a direction away from the third support surface 23. In addition, an opening 48 of the recess 47 is formed at ends of the first portion 41a and the third portion 41c at the third support surface 23 side. The heating unit 31 and the reflector 32 are housed in the recess 47.

As described above, the first member 41 has the opening 48 that opens to the third support surface 23 side, and the recess 47 in which the heating unit 31 and the reflector 32 are housed. In other words, the flow path member 40 has the recess 47 that opens to the third support surface 23 side and in which the heating unit 31 and the reflector 32 are housed.

Furthermore, a wire mesh 49 disposed so as to cover the opening 48 is provided at the flow path member 40. The wire mesh 49 is disposed between the heating unit 31 and the third support surface 23 (medium M). The heat of the heating unit 31 is transferred to the medium M through the wire mesh 49.

An air blowing fan 46, which is an example of an air blowing unit, is disposed in the gas flow path 50. Specifically, the air blowing fan 46 is attached to a center of the second portion 50b in the gas flow path 50. When the air blowing fan 46 is driven, an air flow is generated in the gas flow path 50 so that the gas is sucked from the suction port 44 and is blown out between the third support surface 23 and the heating unit 31 from the outlet 45.

Specifically, as illustrated by a thick arrow in the figure, when the air blowing fan 46 is driven, the gas sucked from the suction port 44 flows through the first portion 50a of the gas flow path 50, the second portion 50b of the gas flow path 50, and the third portion 50c of the gas flow path 50, and is blown from the outlet 45 toward the medium M transported in the transport direction F.

Further, as illustrated by the thick arrow in the figure, most of the gas blown out from the outlet 45 flows in the transport direction F between the wire mesh 49 and the third support surface 23, and is discharged outside the heating unit 30. That is, most of the gas blown out from the outlet 45 is discharged to the opposite side to the location of the recording unit 15.

In addition, as illustrated by a thin arrow in the figure, a part of the gas blown out from the outlet 45 passes through the wire mesh 49 and enters the recess 47, and cools the heating unit 31 and the reflector 32 housed in the recess 47.

A thermostat 61 that stops a current to the heating unit 31 when reaching a predetermined temperature is attached to the gas flow path 50. The thermostat 61 is disposed in the gas flow path 50 and is located in the +Z direction (vertically upward direction) with respect to the heating unit 31.

The temperature of the flow path member 40 forming the gas flow path 50 is approximately 40° C. and the temperature of the thermostat 61 is approximately 40° C., in a state where a current is applied to the heating unit 31 and the air blowing fan 46 and the gas properly flows through the gas flow path 50.

In the present embodiment, when the temperature of the thermostat 61 reaches a predetermined temperature (approximately 70° C.), the thermostat 61 stops a current to the heating unit 31. Therefore, when the temperature of the thermostat 61 is lower than approximately 70° C., the current to the heating unit 31 is maintained, and when the temperature of the thermostat 61 reaches approximately 70° C., the current to the heating unit 31 is stopped.

The thermostat 61 is an example of a first cutting unit in the present application.

A thermostat 62 is attached to a surface of the reflector 32 opposite to the heating unit 31. Of course, the thermostat 62 may be attached to a surface of the reflector 32 at the heating unit 31 side.

The thermostat 62 is disposed so as to be in contact with the reflector 32, and the temperature of the thermostat 62 is the same as the temperature of the reflector 32. The temperature of the reflector 32 is approximately 60° C. and the temperature of the thermostat 62 is approximately 60° C., in a state where the current is applied to the heating unit 31 and the air blowing fan 46 and the gas properly flows through the gas flow path 50.

In the present embodiment, when the temperature of the thermostat 62 reaches a predetermined temperature (approximately 80° C.), the thermostat 62 stops the current to the heating unit 31. Therefore, when the temperature of the thermostat 62 is lower than 80° C., the current to the heating unit 31 is maintained, and when the temperature of the thermostat 62 reaches approximately 80° C., the current to the heating unit 31 is stopped.

The thermostat 62 is an example of a second cutting unit in the present application.

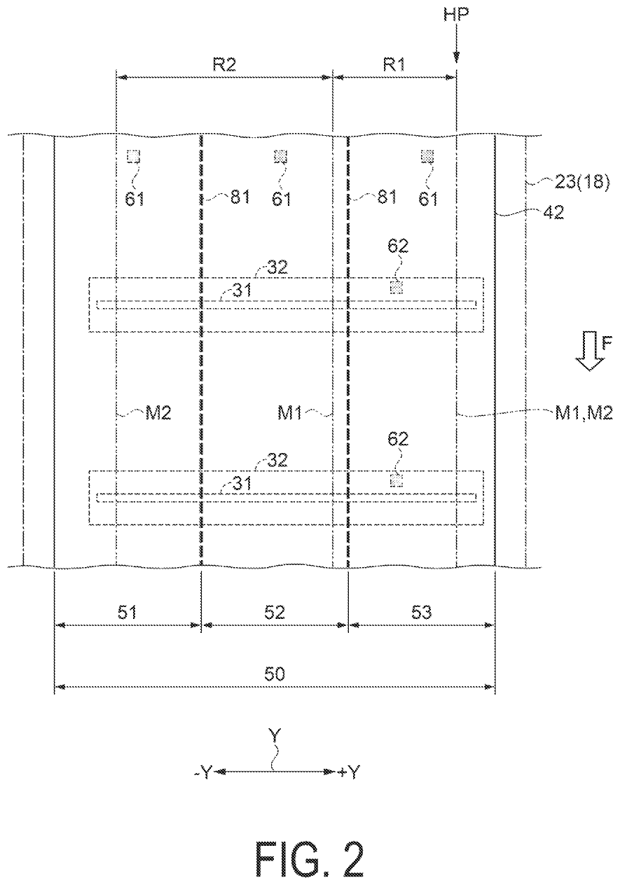

FIG. 2 is a plan view of the heating device 30 viewed in a direction from the second member 42 toward the third support surface 23. The direction from the second member 42 toward the third support surface 23 is a direction orthogonal to the third support surface 23, and in FIG. 2, a state of the heating device 30 in a plan view viewed from the direction orthogonal to the third support surface 23 is illustrated.

In FIG. 2, the third support surface 23 is illustrated by a dot-dash line, the second member 42 is illustrated by a solid line, the heating unit 31, the reflector 32, and the thermostats 61 and 62 are illustrated by thin dashed lines, and a partition member 81 is illustrated by a thick dashed line. Further, the thermostats 61 and 62 are shaded.

The recording apparatus 11 can process the medium M having various sizes, from a medium M having a width direction dimension of 20 inches to a medium M having a width direction dimension of 64 inches. That is, a minimum value of a dimension in the width direction of the medium M that can be processed by the recording apparatus 11 is 20 inches, and the medium M having the dimension in the width direction of 20 inches is referred to as a minimum medium M1. A maximum value of the dimension in the width direction of the medium M that can be processed by the recording apparatus 11 is 64 inches, and the medium M having the dimension in the width direction of 64 inches is referred to as a maximum medium M2. In FIG. 2, the minimum medium M1 and the maximum medium M2 are illustrated by two-dot chain lines.

Further, in the following description, the width direction of the medium M is denoted as a Y-axis direction. One direction of the Y-axis direction is a +Y direction, and the other direction of the Y-axis direction is a −Y direction. Further, a plan view viewed from the direction orthogonal to the third support surface 23 is simply referred to as a plan view.

As illustrated in FIG. 2, in the recording apparatus 11, the minimum medium M1 and the maximum medium M2 are transported in the transport direction F while being supported by the third support surface 23 in a state where an end of the minimum medium M1 in the +Y direction and an end of the maximum medium M2 in the +Y direction are disposed at the same position.

The position where the end of the minimum medium M1 in the +Y direction and the end of the maximum medium M2 in the +Y direction is a reference position HP.

That is, in the recording apparatus 11, the mediums M having different dimensions in the width direction are transported in the transport direction F in a state where the end of the medium M in the +Y direction is aligned with the reference position HP.

The second member 42 forms a housing of the heating device 30, and a dimension of the second member 42 in the Y-axis direction is a dimension of the heating device 30 in the Y-axis direction. In the present embodiment, the dimension of the second member 42 in the Y-axis direction is approximately 2 m. The second member 42 is formed by sheet-metal processing, and constituent material of the second member 42 is iron. Further, the first member 41 is also formed by the sheet-metal processing, and constituent material of the first member 41 is also iron.

The second member 42 forms the cavity that serves as the gas flow path 50 between the second member 42 and the first member 41, and ends of the second member 42 in the +Y direction and the −Y direction are supported by the first member 41. Since the dimension of the second member 42 in the Y-axis direction is as long as approximately 2 m, when the ends thereof in the +Y direction and the −Y direction are supported by the first member 41, the second member 42 bends in the −Z direction due to its own weight. Then, a distance between the first member 41 and the second member 42, that is, a dimension in the direction orthogonal to the third support surface 23 in the gas flow path 50 (referred to as a dimension of the gas flow path 50) becomes non-uniform, and the gas becomes less likely to flow uniformly in the gas flow path 50.

Therefore, in the present embodiment, the partition member 81 is disposed between the first member 41 and the second member 42, and the second member 42 is supported by the partition member 81. The partition member 81 is a member that extends in a direction from the suction port 44 toward the outlet 45. In other words, the partition member 81 is disposed along a direction in which the gas flows in the gas flow path 50. A plurality of the partition member 81 (two in the present embodiment) are disposed at intervals in the Y-axis direction.

By disposing the partition member 81 between the first member 41 and the second member 42, bending of the second member 42 due to its own weight is suppressed, the dimension of the gas flow path 50 becomes uniform, and mechanical strength of the flow path member 40 is increased.

The gas flow path 50 is partitioned into a plurality of flow paths including a first flow path 51, a second flow path 52, and a third flow path 53 by the partition member 81. Further, the thermostat 61 is disposed at each of the first flow path 51, the second flow path 52, and the third flow path 53.

As described above, the present embodiment has a configuration in which the gas flow path 50 is partitioned into the plurality of flow paths by the partition member 81 extending in the direction from the suction port 44 toward the outlet 45, and the thermostat 61 is provided at each of the plurality of flow paths (the first flow path 51, the second flow path 52, and the third flow path 53) into which the gas flow path 50 is partitioned.

Of course, the heating device 30 may have a configuration in which the partition member 81 is not provided between the first member 41 and the second member 42.

In the configuration in which the partition member 81 is not provided between the first member 41 and the second member 42, the dimension in the Y-axis direction of the gas flow path 50 is longer than the configuration in which the gas flow path 50 is partitioned into the plurality of flow paths by the partition member 81. In this case, a plurality of the thermostat 61 may be provided in the gas flow path 50 at intervals in the Y-axis direction, or a single thermostat 61 may be provided in the gas flow path 50.

When the bending of the second member 42 due to its own weight is suppressed by the partition member 81, each of dimensions of gas flow paths 51, 52, and 53 in the first flow path 51, the second flow path 52, and the third flow path 53 becomes the same, and the dimensions of the gas flow path 50 in the first flow path 51, the second flow path 52, and the third flow path 53 becomes uniform. Then, the gas flows uniformly in each of the plurality of flow paths into which the gas flow path 50 is partitioned (the first flow path 51, the second flow path 52, and the third flow path 53).

A dimension of the heating unit 31 in the Y-axis direction is longer than the dimension of the maximum medium M2 in the Y-axis direction, and in the plan view, the maximum medium M2 is disposed inside the heating unit 31. As a result, when the maximum medium M2 is transported in the transport direction F, the heating unit 31 can heat the entire maximum medium M2. Of course, when the minimum medium M1 is transported in the transport direction F, the heating unit 31 can heat the entire minimum medium M1.

In FIG. 2, when the mediums M of various sizes are transported in the transport direction F, a region where the third support surface 23 is covered by the mediums M of various sizes is a region R1. For example, even when the minimum medium M1 is transported in the transport direction F, and even when the maximum medium M2 is transported in the transport direction F, the third support surface 23 is covered by the medium M in the region R1. As described above, in the region R1, when the mediums M of various sizes are transported in the transport direction F, the third support surface 23 is covered by the medium M, and the third support surface 23 is not exposed.

In FIG. 2, when the mediums M of various sizes are transported in the transport direction F, depending on the size of the medium M, a region where the third support surface 23 may not be covered by the medium M is a region R2. For example, in the region R2, when the minimum medium M1 is transported in the transport direction F, the third support surface 23 is not covered by the minimum medium M1, and when the maximum medium M2 is transported in the transport direction F, the third support surface 23 is covered by the maximum medium M2. As described above, in the region R2, when the mediums M of various sizes are transported in the transport direction F, there are cases where the third support surface 23 is not covered by the medium M and is exposed, and where the third support surface 23 is covered by the medium M and is not exposed.

The thermostat 62 is disposed in the region R1 where the third support surface 23 is covered by the medium M and is not exposed when the mediums M of various sizes are transported in the transport direction F.

Constituent material of the third support surface 23 is a metal having excellent thermal conductivity such as aluminum. On the other hand, constituent material of the medium M is an organic material such as cellulose or polyester.

Accordingly, when the mediums M of various sizes are transported in the transport direction F, the thermostat 62 is disposed so as to overlap the mediums M formed from an organic material such as cellulose, polyester, or the like, and is not disposed so as to overlap the third support surface 23 formed from a metal having excellent thermal conductivity such as aluminum, in a plan view viewed from the direction orthogonal to the third support surface 23.

As described above, the present embodiment has a configuration in which in the plan view viewed from the direction orthogonal to the third support surface 23, the thermostat 62 is disposed so as to overlap the medium M.

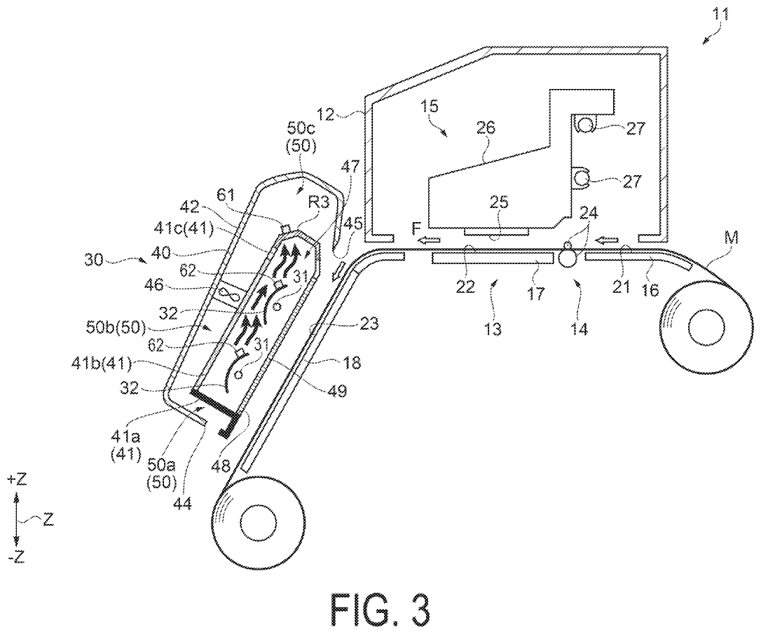

FIG. 3 is a diagram corresponding to FIG. 1, and is a schematic cross-sectional view illustrating a state of the recording apparatus 11 when the air blowing fan 46 is stopped.

In FIG. 3, a flow state of the gas heated by the heating unit 31 is illustrated by a thick arrow. Further, in FIG. 3, a portion of the first member 41 where the temperature rises significantly when the air blowing fan 46 is stopped is hatched. Further, a region where the temperature rises significantly in the first member 41 is referred to as a heat storage region R3 of the first member 41. In the third portion 41c of the first member 41, a portion located in the +Z direction (vertically upward direction) becomes the heat storage region R3.

The heat storage region R3 of the first member 41 is an example of a portion of the flow path member where the heat of the heating unit is easily propagated by convection in the present application.

The heat rays of the heating unit 31 are reflected by the reflector 32 toward the medium M. A part of the heat rays of the heating unit 31 is absorbed by the reflector 32, and the reflector 32 is heated by radiation. Further, when the air blowing fan 46 is driven, the heating unit 31, the reflector 32, and the first member 41 forming the recess 47 are cooled by the gas blown from the outlet 45.

Therefore, when the air blowing fan 46 is stopped and the gas does not flow in the gas flow path 50, the temperature of the reflector 32 rises.

On the other hand, when the air blowing fan 46 stops due to defects of the air blowing fan 46, electrical wirings (not illustrated), or the like, the gas is heated by the heat of the heating unit 31 or the heat of the reflector 32, and the heated gas becomes ascending air flow and flows in the +Z direction (vertically upward direction), as illustrated by the thick arrow in FIG. 3.

The heated gas stays in the third portion 41c of the first member 41 located in the +Z direction (vertically upward direction) with respect to the heating unit 31 and the reflector 32, and in particular, the portion (the heat storage region R3) located in the +Z direction (vertically upward direction) in the third portion 41c is heated. That is, a portion where the temperature rises most in the flow path member 40 when the air blowing fan 46 is stopped is the heat storage region R3. In other words, a portion in the flow path member 40 where the heat of the heating unit 31 is easily propagated by the convection when the air blowing fan 46 is stopped, is the heat storage region R3.

The thermostat 61 is attached to a portion (heat storage region R3) where the temperature of the flow path member 40 easily rises when the air blowing fan 46 stops. In other words, the thermostat 61 is attached to a portion (heat storage region R3) in the flow path member 40 where the heat of the heating unit 31 is easily propagated by the convection when the air blowing fan 46 is stopped.

The temperature of the thermostat 61 and the temperature of the heat storage region R3 are the same.

The heating device 30 includes the heating unit 31 disposed at the downstream of the recording unit 15 in the transport direction F and configured to heat the medium M in a non-contact manner, and the air blowing fan 46 that generates an air flow in the gas flow path 50 so that the gas is blown out between the third support surface 23 and the heating unit 31 from the outlet 45. In the heating device 30, the heating unit 31 heats the medium M transported in the transport direction F in a non-contact manner in a state where the gas is blown from the outlet 45 to the medium M, and evaporates the water in the ink attached to the medium M and dries the medium M.

Since gas heated by the heating unit 31 and containing steam is discharged to the outside of the heating device 30 by the gas blown from the outlet 45, the gas does not stay at the vicinity of the medium M. Therefore, the evaporation of the water in the ink is promoted, and the medium M is dried quickly.

That is, since the heating device 30 simultaneously performs drying by heating and drying by blowing air, drying speed of the medium M is faster than a case where only drying by heating is performed.

For example, when the gas heated by the heating unit 31 and containing steam is discharged to the recording unit 15 side, the recording unit 15 is warmed and recording quality of the recording unit 15 is likely to be adversely affected. In the present embodiment, since the gas heated by the heating unit 31 and containing steam is discharged to the opposite side to the recording unit 15 (downstream of the transport direction F), the recording unit 15 is not warmed and the recording quality of the recording unit 15 is less likely to be adversely affected.

For example, if the temperature of the medium M becomes too high by the heating unit 31, the quality of the medium M deteriorates, and problems such as discoloration of the medium M and deformation of the medium M occur. The gas blown from the outlet 45 cools the medium M so that the temperature of the medium M does not become too high, and suppresses deterioration of the quality of the medium M.

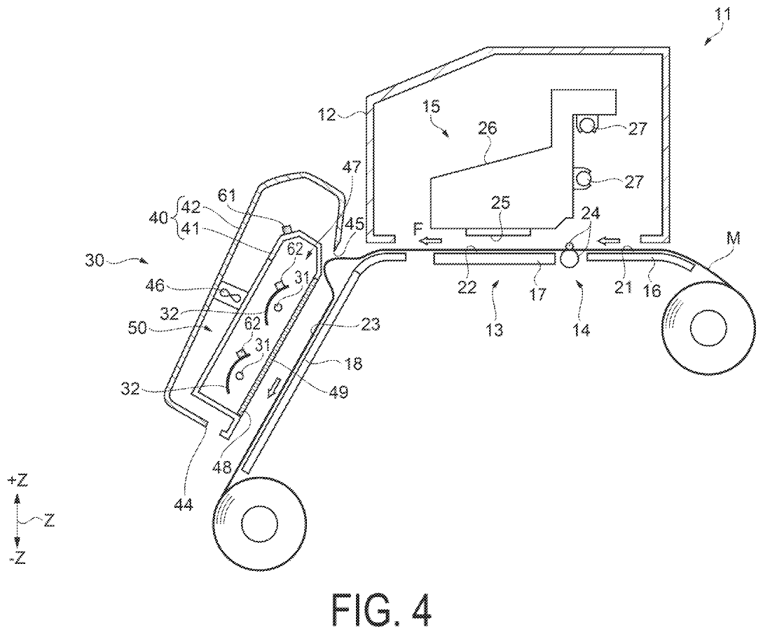

For example, as illustrated in FIG. 4, the medium M is lifted from the third support surface 23 due to jam (paper jam) of the medium M, the outlet 45 is blocked by the medium M, and thus it becomes difficult for the gas to be blown out from the outlet 45, in some cases. In this case, if it becomes difficult to blow the gas from the outlet 45, the temperature of the medium M becomes too high, and the quality of the medium M may deteriorate.

In addition, when it becomes difficult to blow the gas from the outlet 45, the reflector 32 is less likely to be cooled and the temperature of the reflector 32 rises, so that the temperature rise of the medium M and the temperature rise of the reflector 32 have a positive correlation. Therefore, from the temperature rise of the reflector 32, it is possible to predict the temperature rise of the medium M which causes quality deterioration of the medium M.

In the following description, the temperature rise of the medium M which causes the quality deterioration of the medium M is referred to as an excessive temperature rise of the medium M.

In the present embodiment, the thermostat 62 is attached to the reflector 32, and the thermostat 62 operates and the current to the heating unit 31 is stopped before the excessive temperature rise of the medium M occurs. Specifically, in a case where it becomes difficult for the gas to be blown from the outlet 45 and the temperature both of the reflector 32 and the medium M rise, when the temperature of the reflector 32 (temperature of the thermostat 62) is lower than approximately 80° C., the excessive temperature rise of the medium M does not occur. Further, if the temperature of the reflector 32 (temperature of the thermostat 62) reaches 80° C., the quality deterioration of the medium M may occur due to the excessive temperature rise of the medium M. Therefore, when the temperature of the thermostat 62 reaches 80° C. (predetermined temperature), the thermostat 62 operates, the current to the heating unit 31 is stopped, and thus the medium M is not heated by the heating unit 31. As a result, the excessive temperature rise of the medium M is suppressed.

Further, when the temperature of the thermostat 62 becomes lower than 80° C., the excessive temperature rise of the medium M does not occur, so that the thermostat 62 operates, the current to the heating unit 31 is resumed, and the medium M is heated by the heating unit 31.

As described above, the present embodiment has a configuration in which when the temperature of the thermostat 62 reaches the predetermined temperature (80° C.), the current to the heating unit 31 is stopped, and the medium M is not heated by the heating unit 31. According to such a configuration, it is suppressed that the medium M is excessively heated by the heating unit 31, and the quality of the medium M deteriorates.

When the medium M is lifted from the third support surface 23 due to jam of the medium M, the outlet 45 is blocked by the medium M, and it becomes difficult to blow out the gas from the outlet 45, it becomes difficult to flow the gas in the gas flow path 50. Therefore, the temperature of the heat storage region R3 of the first member 41 rises due to convection, and the temperature of the thermostat 61 attached to the heat storage region R3 of the first member 41 rises. Accordingly, it is possible to predict the excessive temperature rise of the medium M and to suppress quality deterioration of the medium M.

However, the temperature change of the heat storage region R3 of the first member 41 whose temperature rises due to convection is slower than the temperature change of the reflector 32 heated by radiation. That is, when it becomes difficult to blow the gas from the outlet 45, the temperature of the reflector 32 rises quickly, and the temperature of the heat storage region R3 of the first member 41 rises slowly. Therefore, the problem that occurs when it becomes difficult to blow the gas from the outlet 45, can be appropriately addressed by the temperature change of the reflector 32 heated by radiation, and is hard to be appropriately addressed by the temperature change of the heat storage region R3 of the first member 41 where the temperature rises due to convection.

Therefore, when it becomes difficult for the gas to be blown out from the outlet 45, it is preferable to suppress the excessive temperature rise of the medium M by the thermostat 62 attached to the reflector 32.

The heating device 30 according to the present embodiment includes a thermistor (not illustrated) in addition to the thermostats 61 and 62, the temperature is also detected by the thermistor, and when an abnormality in the temperature is detected, the current to the heating unit 31 can be stopped. However, when the thermistor is used, control of the heating unit 31 becomes slower than when the thermostats 61 and 62 are used, and it becomes difficult to quickly stop the current to the heating unit 31 and to quickly resume the current to the heating unit 31.

In many cases, the jam of the medium M described above is easily resolved. Further, when the jam of the medium M is resolved, it is desirable to restart the processing by the recording apparatus 11 as soon as possible. When the thermostats 61 and 62 are used, the current to the heating unit 31 can be resumed more quickly and the processing by the recording apparatus 11 can be restarted more quickly than when the thermistor is used.

For example, when an excessive current flows through the heating unit 31, the intensity of the heat rays irradiated from the heating unit 31 becomes too strong, the temperature both of the reflector 32 and the medium M become high, and the temperature of the medium M becomes too high, the quality of the medium M may deteriorate.

In a case where the excessive current flows through the heating unit 31 and the intensity of the heat rays irradiated from the heating unit 31 is too strong, when the temperature of the reflector 32 (temperature of the thermostat 62) is lower than approximately 80° C., the excessive temperature rise of the medium M does not occur, and when the temperature of the reflector 32 (temperature of the thermostat 62) reaches 80° C., the excessive temperature rise of the medium M may occur, as in the case where it becomes difficult to blow the gas from the outlet 45. Therefore, when the temperature of the thermostat 62 reaches 80° C. (predetermined temperature), the thermostat 62 operates, the current to the heating unit 31 is stopped, and thus the medium M is not heated by the heating unit 31.

Therefore, even in a case where excessive current flows through the heating unit 31 and the intensity of the heat rays irradiated from the heating unit 31 is too strong, it is suppressed that the medium M is excessively heated by the heating unit 31, and the quality of the medium M deteriorates.

For example, when the minimum medium M1 is transported in the transport direction F, the third support surface 23 is covered by the medium M and is not exposed in the region R1, and the third support surface 23 is not covered by the medium M and is exposed in the region R2.

In the present embodiment, the thermostat 62 is attached to the region R1 of the reflector 32. Further, when the minimum medium M1 is transported in the transport direction F, the thermostat 62 attached to the region R1 of the reflector 32 is disposed to overlap the medium M in a plan view viewed from the direction orthogonal to the third support surface 23.

If the thermostat 62 is attached to the region R2 of the reflector 32, when the minimum medium M1 is transported in the transport direction F, the thermostat 62 attached to the region R2 of the reflector 32 is disposed to overlap the third support surface 23 in the plan view viewed from the direction orthogonal to the third support surface 23.

When the minimum medium M1 is transported in the transport direction F, the region R1 of the reflector 32 is heated by heat rays of the heating unit 31 directly irradiated and heat rays of the heating unit 31 indirectly irradiated by reflection of the medium M. In this way, the region R1 of the reflector 32 is heated by the heat rays of the heating unit 31 which is indirectly irradiated by the reflection of the medium M.

On the other hand, when the minimum medium M1 is transported in the transport direction F, the region R2 of the reflector 32 is heated by the heat rays of the heating unit 31 directly irradiated and heat rays of the heating unit 31 indirectly irradiated by reflection of the third support surface 23. That is, the region R2 of the reflector 32 is heated by the heat rays of the heating unit 31 which is indirectly irradiated by the reflection of the third support surface 23.

The constituent material of the medium M is an organic material such as cellulose, polyester, the constituent material of the third support surface 23 is a metal such as aluminum, and the third support surface 23 is more likely to reflect the heat rays (infrared rays) of the heating unit 31 than the medium M. Therefore, the intensity of the heat rays of the heating unit 31 indirectly irradiated by the reflection of the third support surface 23 is stronger than the intensity of the heat rays of the heating unit 31 indirectly irradiated by the reflection of the medium M.

Accordingly, the temperature of the region R2 of the reflector 32 heated by the heat rays of the heating unit 31 indirectly irradiated by the reflection of the third support surface 23 becomes higher than the temperature of the region R1 of the reflector 32 heated by the heat rays of the heating unit 31 indirectly irradiated by the reflection of the medium M.

As a result, when the minimum medium M1 is transported in the transport direction F, the temperature of the thermostat 62 attached to the region R1 of the reflector 32 becomes lower than the temperature of the thermostat 62 attached to the region R2 of the reflector 32.

Specifically, when the minimum medium M1 is transported in the transport direction F, the temperature of the thermostat 62 attached to the region R1 of the reflector 32 is approximately 40° C., and thus a temperature difference between the thermostat 62 and the temperature at which the thermostat 62 operates (approximately 80° C.) is approximately 40° C. On the other hand, when the minimum medium M1 is transported in the transport direction F, the temperature of the thermostat 62 attached to the region R2 of the reflector 32 is approximately 60° C., and thus the temperature difference between the thermostat 62 and the temperature at which the thermostat 62 operates (approximately 80° C.) is approximately 20° C.

In the present embodiment, since the thermostat 62 is attached to the region R1 of the reflector 32, the temperature difference between the thermostat 62 and the temperature at which the thermostat 62 operates (approximately 80° C.) is approximately 40° C. On the other hand, when the thermostat 62 is attached to the region R2 of the reflector 32, the temperature difference between the thermostat 62 and the temperature at which the thermostat 62 operates (approximately 80° C.) is approximately 20° C.

The temperature difference between the thermostat 62 and the temperature at which the thermostat 62 operates is a temperature difference between the temperatures of the thermostat 62 in normal state and in abnormal state. When the temperature difference from the temperature at which the thermostat 62 operates becomes large, the thermostat 62 is less likely to malfunction, and when the temperature difference from the temperature at which the thermostat 62 operates becomes small, the thermostat 62 is likely to malfunction.

In the present embodiment, since the thermostat 62 is attached to the region R1 of the reflector 32, the temperature difference from the temperature at which the thermostat 62 operates becomes large. Therefore, the thermostat 62 is less likely to malfunction, and the thermostat 62 operates properly. As a result, it is suppressed that the medium M is excessively heated by the heating unit 31, and the quality of the medium M deteriorates.

On the other hand, when the thermostat 62 is attached to the region R2 of the reflector 32, the temperature difference from the temperature at which the thermostat 62 operates becomes small, and thus the thermostat 62 tends to malfunction. Therefore, even when it is not necessary to stop the current to the heating unit 31, the current to the heating unit 31 may be stopped.

Accordingly, a configuration in which the thermostat 62 is attached to the region R1 of the reflector 32, that is, in a plan view viewed from the direction orthogonal to the third support surface 23, in which the thermostat 62 is disposed so as to overlap the medium M is preferable.

For example, when the air blowing fan 46 is stopped, gas is not blown out from the outlet 45. Thus, the medium M is not cooled by the gas blown out from the outlet 45, and the temperature of the medium M rises, and therefore the quality of the medium M may deteriorate.

In the present embodiment, since the thermostat 61 is attached to a portion (heat storage region R3) of the flow path member 40 where the temperature rises most easily when the air blowing fan 46 is stopped, the thermostat 61 operates and the current to the heating unit 31 is stopped before the excessive temperature rise of the medium M occurs.

Specifically, in a case where the air blowing fan 46 is stopped and the gas is no longer blown out from the outlet 45, so that the temperature both of the heat storage region R3 of the first member 41 and the medium M rise, when the temperature of the heat storage region R3 of the first member 41 (temperature of the thermostat 61) is lower than approximately 70° C., the excessive temperature rise of the medium M does not occur, and when the temperature of the heat storage region R3 of the first member 41 (temperature of the thermostat 61) reaches 70° C., the quality of the medium M may deteriorate due to the excessive temperature rise of the medium M. Therefore, when the temperature of the thermostat 61 reaches 70° C. (predetermined temperature), the thermostat 61 operates, the current to the heating unit 31 is stopped, and the medium M is not heated by the heating unit 31. Further, when the temperature of the thermostat 61 becomes lower than 70° C., the thermostat 61 operates, the current to the heating unit 31 is resumed, and the medium M is heated by the heating unit 31.

As described above, the present embodiment has a configuration in which when the temperature of the thermostat 61 reaches the predetermined temperature (70° C.), the current to the heating unit 31 is stopped, and the medium M is not heated by the heating unit 31. According to such a configuration, it is suppressed that the medium M is excessively heated by the heating unit 31, and the quality of the medium M deteriorates.

As described above, the heating device 30 according to the present embodiment simultaneously performs drying by heating and drying by blowing air, and can quickly dry the medium M while suppressing an adverse effect on the recording quality of the recording unit 15.

In addition, the heating device 30 according to the present embodiment can appropriately detect an abnormality in temperature (excessive temperature rise of the medium M) even it has a configuration in which drying by heating and drying by blowing air are simultaneously performed. Specifically, by disposing the thermostats 61 and 62 which detect in advance an abnormality in temperature (excessive temperature rise of the medium M) at appropriate positions in the heating device 30, the heating device 30 operates the thermostats 61 and 62 and stops the current to the heating unit 31 prior to the excessive temperature rise of the medium M, and therefore the excessive temperature rise of the medium M and quality deterioration of the medium M can be suppressed.

What is claimed is:

1. A heating device configured to heat a medium supported by a support surface inclined in a vertically downward direction toward downstream in a transport direction and transported in the transport direction, the heating device comprising:
a heating unit disposed facing the support surface and configured to heat the medium in a non-contact manner;
a reflector configured to reflect heat rays of the heating unit toward the medium;
a flow path member disposed at an opposite side to the support surface with respect to the heating unit and is inclined in a vertically upward direction toward upstream in the transport direction, the flow path member including
a suction port disposed in the vertically downward direction,
an outlet disposed in the vertically upward direction, and
a gas flow path disposed between the suction port and the outlet;
an air blowing unit configured to generate an air flow in the gas flow path so that gas is sucked from the suction port and is blown out, from the outlet, to a portion between the support surface and the heating unit;
a first cutting unit disposed in the gas flow path and located in the vertically upward direction with respect to the heating unit, the first cutting unit being configured to stop supplying current to the heating unit when a predetermined temperature is reached; and
a second cutting unit in contact with the reflector, the second cutting unit being configured to stop supplying the current to the heating unit when a predetermined temperature is reached.

2. The heating device according to claim 1, wherein
the first cutting unit is attached to a portion of the flow path member where heat of the heating unit is easily propagated by convection.

3. The heating device according to claim 1, wherein
the gas flow path is partitioned into a plurality of flow paths by a partition member extending in a direction from the suction port toward the outlet, and
the first cutting unit is provided at each of the plurality of flow paths obtained by partitioning the gas flow path.

4. The heating device according to claim 1, wherein
in a plan view viewed from a direction orthogonal to the support surface, the second cutting unit is disposed so as to overlap the medium.
